(19) United States
(12) Patent Application Publication
(10) Pub. No.: US 2007/0176912 A1
(43) Pub. Date: Aug. 2, 2007

(54) Portable memory devices with polymeric displays

(76) Inventors: Michael H. Beames, Salt Lake City, UT (US); Alex Lin, Taipei (TW)

Correspondence Address: HICKMAN PALERMO TRUONG & BECKER, LLP, 2055 GATEWAY PLACE, SUITE 550, SAN JOSE, CA, 95110, US

(21) Appl. No.: 11/636,407

(22) Filed: Dec. 7, 2006

Related U.S. Application Data
(60) Provisional application No. 60/748,780, filed on Dec. 9, 2005.

(51) Int. Cl. G09G 5/00; G06F 3/038

(52) U.S. Cl. 345/204

(57) ABSTRACT

A portable memory device having a flexible polymeric display panel which comprises a memory controller configured to determine memory information from a memory coupled to the memory controller, generate memory information signals in dependence on the determined memory information and output the memory information signals to a display driver. The display driver is configured to convert the memory information signals into visual representation signals. The visual representation signals are then outputted on the flexible polymeric display panel. In one embodiment, a secure digital (SD) flash memory card has an electrophoretic display on the card housing and the display indicates information such as the amount of storage available in the card.

### CROSS-REFERENCE TO RELATED APPLICATIONS; PRIORITY CLAIM

This application claims benefit under 35 U.S.C. §119(e) of co-pending Provisional Application Ser. No. 60/748,780, filed Dec. 9, 2005, to the instant inventors and a common assignee, the entire contents of which is hereby incorporated by reference for all purposes as if fully set forth herein.

### FIELD OF THE INVENTION

The various embodiments presented herein generally relate to memory devices and flexible polymeric displays.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Current industry standards and consumer devices manufactured to be compliant with the various industry standards constrain the physical dimensions of memory devices. For example, industry standards define the thickness of Secure Digital (SD) memory cards to be 1.4 millimeters (mm.) Therefore it is physically impossible to comply with the standard by integrating a display panel into such a memory device if the combined thickness of the memory device and the display is greater than 1.4 mm.

In addition, existing non-volatile memory devices use low power operation and typically demand power only when connected and being updated. However, currently available display panels such as liquid crystal display (LCD) panels are power consuming, demanding a constant source of power to maintain images, which presents another difficulty encountered with the integration of a display panel into memory devices.

Manufacturing of display panels within memory device packaging is also constrained by pressure requirements during assembly. Glass containing display products could fracture under these pressure conditions and therefore would not be suitable for such product packaging. Furthermore, memory devices need to withstand a certain level of impact shock, jarring, bending and other environmental and handling conditions. As such, glass-based display panels may shatter, causing display malfunctions and possibly presenting a hazard to users.

Because memory products are constrained by so many physical, manufacturing and operational conditions, integration of display panels into these devices has been a challenge.

### BRIEF DESCRIPTION OF THE DRAWINGS

Various embodiments are illustrated by way of examples, and not by way of limitation, in the figures of the accompanying drawings and in which like reference numerals refer to similar elements and in which:

FIG. 1 illustrates an embodiment where a polymeric display panel is operatively coupled to a memory device.

FIG. 2A illustrates a memory device in a secure digital (SD) form factor in which a polymeric display panel is encompassed longitudinally within the memory device.

FIG. 2B illustrates another memory device in a SD form factor in which a polymeric display panel is encompassed laterally within the memory device.

FIG. 2C illustrates another memory device in a secure digital (SD) form factor in which a polymeric display panel is encompassed paracentrally within the memory device.

FIG. 2D illustrates another memory device in a universal serial bus (USB) flash drive form factor in which a polymeric display panel is encompassed laterally within the memory device.

### DESCRIPTION OF EXAMPLE EMBODIMENTS

Various embodiments of memory devices with flexible polymeric displays are described herein. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Embodiments are described herein according to the following outline:
1.0 General Overview
2.0 Structural and Functional Overview
3.0 Implementation Mechanisms—Hardware Overview
4.0 Extensions and Alternatives

1.0 General Overview

The needs identified in the foregoing Background, and other desirable embodiments will become apparent in the various example embodiments described herein. In one embodiment, a portable memory device having a flexible polymeric display panel comprises a memory controller which is configured to determine memory information from a memory coupled to the memory controller, generate memory information signals in dependence on the determined memory information and output the memory information signals to a display driver. The display driver is configured to convert the memory information signals into visual representation signals which are then outputted by the display driver on the flexible polymeric display panel in a visually perceivable format. In one embodiment, a secure digital (SD) flash memory card has an electrophoretic display on the card housing and the display indicates information such as the amount of storage available in the card.

In one embodiment, the display driver may include a microcontroller.

In another embodiment, the flexible polymeric display panel may be one of an electrophoretic display, a polymer dispersed liquid crystal display, a cholesteric liquid crystal display, an organic light emitting devices display, a plastic-based liquid crystal display, and an electronic paper display.

In another embodiment, the portable memory device may be embodied in various form factors, for example, a secure data card, COMPACTFLASH® flash memory card, a memory stick and a USB flash drive.

In another embodiment, an image displayed on the flexible polymeric display panel is persistent without application of electrical power. In another embodiment, the memory coupled to the memory controller is sharable with the display driver.

In another embodiment, the flexible polymeric display panel has a thickness in a range of about 100 to about 950 micrometers. In another embodiment, the flexible polymeric display panel has a thickness in a range of about 250 to about 450 micrometers.

In another embodiment, the flexible polymeric display panel is coupled to a housing encompassing the portable memory device. In another embodiment, the flexible polymeric display panel is coupled to an area of the housing on any of the following surfaces; an interior surface, an exterior surface and between the interior and exterior surfaces.

In yet another embodiment, the memory may include one or more of the following: a read-only memory, a programmable read-only memory, an erasable programmable read-only memory, an electrically erasable programmable read-only memory, a flash memory and a random access memory. In other embodiments, the memory may comprise any other form of memory now known or invented hereafter. In still another embodiment, the displayed information may indicate a total memory capacity, an available memory; assigned memory, a graphical image, alphanumeric text and any combinations thereof.

2.0 Structural and Functional Overview

Flexible display panels are integrated into portable memory devices. The integrated display panels may be customized and programmable to display various information or images. Example information and images include the remaining storage capacity of the memory device, the amount of storage currently used in the memory device, advertising images, an image that identifies an owner or user of the memory device, or any other image.

The portable memory devices suitable for use in the various embodiments may include, but are not limited to, read-only memory (ROM), programmable read-only memory (PROM), erasable programmable read-only memory (EPROM), electrically erasable programmable read-only memory (EEPROM), flash random access memory (RAM) and volatile memory devices in its various forms for example, static RAM (SRAM) or dynamic RAM (DRAM) is also feasible. In other embodiments, the memory may comprise any other form of memory now known or invented hereafter.

In various preferred embodiments, flash memory devices such as USB Flash Drives, Compact Flash (CF) cards, Secure Digital (SD) cards, memory stick, MultiMedia cards (MMC), SmartMedia cards (SMC) and the like, and random access memory (RAM) powered with batteries and miniature hard drives benefit by the integration of a flexible display panel. These various forms of flash memory devices allow for both serial and random access of their associated flash memories, consume small amounts of power and may be operated over a wide range of supply voltages. As such, these flash memory devices are useful in mobile, battery-powered implementations such as portable media players, organizers, portable data assistants, cellular telephones and electronic books.

Many different types of display panels are suitable for integration into the memory devices, including flexible polymeric display panels. Such flexible polymeric display panels may include, but are not limited to, electrophoretic displays (EPDs), polymer dispersed liquid crystal displays (PDLCs), cholesteric liquid crystal displays (ChLCD), organic light emitting devices (OLEDs) displays, plastic-based LCDs, or other particle based displays which may include flipping ball displays as described in T. Pham et al, SID 02 Digest, p. 119 (2002) or a liquid powder display as described in R. Hattori et al, SID 03 Digest, p. 846 (2003.)

Examples of electrophoretic displays that can be used herein include the microcup-based EPD disclosed in U.S. Pat. Nos. 6,831,781, issued Dec. 14, 2004; 6,833,943 issued Dec. 21, 2004; 6,867,898, issued Mar. 15, 2005; and 6,930,818 issued Aug. 16, 2005.

In an embodiment, a display panel has a thickness in the range of about 100 to about 950 μm or a range of about 250 to about 450 μm. For example, an embodiment may use a display panel with an electrophoretic film display panel from SiPix Imaging, Inc., Fremont, Calif., having a thickness of about 150 μm. Other embodiments may use display panels with thinner PET material in combination with certain materials such as sputtered metals that provide a display stack of less than 150 μm. In an embodiment, a display panel also can withstand blunt pressures that may be encountered during manufacturing processes. For example, polymeric display panels can withstand typical manufacturing processes and also are tolerant of flexing and bending in normal usage.

In an embodiment, a display panel provides a persistent image that does not require power except when being updated or refreshed, thus eliminating the need for a power source while being handled and/or transported.

The display panel may present a variety of information to a user. Example information includes, but is not limited to, the remaining memory on the memory device, total memory, memory used, logos, alphanumeric text, and graphical images. The display panel may be custom shaped for placement within the memory device housing.

The portable memory device may be constructed of a suitable polymer or combined with a metallic shell to protect the memory and associated components contained within the housing.

3.0 Implementation Mechanisms—Hardware Overview

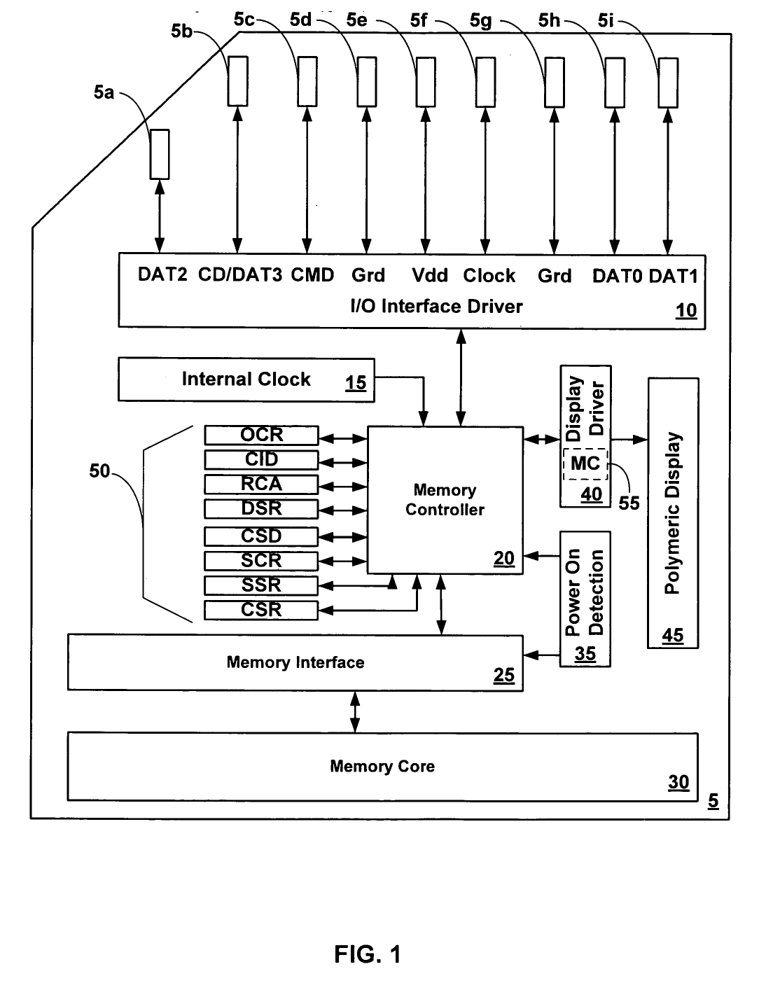

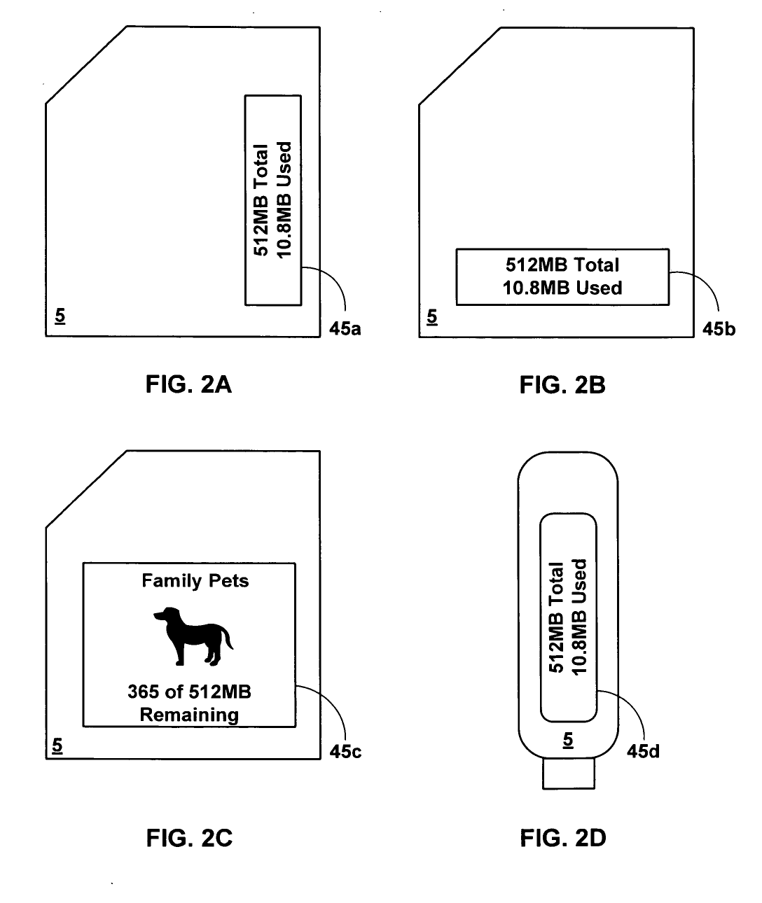

FIG. 1 illustrates an embodiment where a polymeric display panel is operatively coupled to a memory device. FIG. 2A illustrates a memory device in a secure digital (SD) form factor in which a polymeric display panel is encompassed longitudinally within the memory device. FIG. 2B illustrates another memory device in a SD form factor in which a polymeric display panel is encompassed laterally within the memory device. FIG. 2C illustrates another memory device in a secure digital (SD) form factor in which a polymeric display panel is encompassed paracentrally within the memory device. FIG. 2D illustrates another memory device in a universal serial bus (USB) flash drive form factor in which a polymeric display panel is encompassed laterally within the memory device.

Referring first to FIG. 1, an example block diagram is depicted that illustrates an embodiment where a polymeric display panel is operatively coupled to a memory device. In this example embodiment, the portable memory device 5 is embodied in a SD card form factor.

Memory device 5 comprises a plurality of electrical contacts 5a-5i that allow the memory device to receive power and communicate with an external electronic device such as a computer system or digital camera. The plurality of electrical contacts 5a-5i includes four data channels 5a, 5b, 5h, 5i, three power connections 5d, 5e, 5g, a command channel 5c, and a connection to an external clock 5f. One of the data channels 5b also serves as an interrupt for detection of device insertion or removal from the external electronic device.

The electrical contacts 5a-5i are electrically coupled to an input/output (I/O) device driver 10 circuit. The I/O device driver circuit 10 is used to transfer electrical power, data, memory addresses where data items are to be found and control signals to a memory controller 20. The memory controller 20 is typically a microcontroller. The microcontroller contains dedicated memory, programmable instructions, a microprocessor having a plurality of industry standard external registers 50 and the interfaces necessary for performing the various functions of the portable memory device 5. A power on detection circuit 35 is provided to allow the memory controller 20 to initialize and return to a proper state to perform, for example, read, write and erase operations.

An internal clock 15 is coupled to the memory controller 20 to synchronize the various functions (e.g., read, write and erase) of the portable memory device 5.

In an embodiment, a memory interface 25 is coupled to the memory controller 20. The memory interface 25 provides a standardized way of addressing of the flash memory core 30 among various vendors and also provides for forward and backward compatible software support for specified flash device families. The standardized memory interface 25 minimizes the need for an operating system or operating environment from having to maintain device specific driver information to use the portable memory device 5.

The memory core 30 contains the actual data storage area for memory device 5. In an embodiment, memory core 30 is flash memory.

A display driver circuit 40 is provided to convert memory information signals generated by the memory controller 20 into visual representation signals capable of driving a polymeric display 45. The polymeric display 45 may comprise a display panel. The conversion may include voltage adjustment and image refresh rates. In an embodiment, the display driver circuit 40 includes a microcontroller 55 to perform the necessary functions to drive the polymeric display 45. The display driver circuit 40 may be incorporated into an integrated circuit (IC.) The display driver circuit 40 may be driven by the memory controller 20 in parallel using a certain number of general purpose I/O ports (GPIOs) available on the memory controller 20 or may be serially driven using for example, I-squared-C (I2C) mechanisms.

In an alternative embodiment, display driver circuit 40 is omitted, and a memory device comprises a memory device housing having a display but without a display driver on board. In such an embodiment, the display is driven from the external system into which the memory device is plugged, using a waveform with correct voltage levels on the memory electrical interface or bus that is coupled to the external system.

Memory device 5 may comprise other passive components depending on the I/O structure of the display driver circuit 40. These other components may be coupled to the display driver circuit 40 and may include internal DC/DC charge pumps for adjusting the memory information signals obtained from the memory controller 20 to the operating voltage required by the polymeric display 45.

The memory controller 20 or microcontroller 55 associated with the display driver circuit 40 may require the use of some of the memory 30. In an embodiment, a portion of the memory 30 may be allocated to the memory controller 20. Alternately, an external register 50 of the memory controller 20 is provided to maintain the memory information concerning the state of the memory 30, i.e., how much memory is free and/or used on the portable memory device 30. In this embodiment, the memory controller 20 periodically updates the register 50 with memory information as directed by its associated firmware instructions.

In one embodiment, the memory controller 20 is programmed with firmware to directly provide the display driver circuit 40 with memory information either periodically and/or in conjunction with an achieved conditional memory state (e.g., memory used equaling 20%, 40%, 60%, etc.), other preprogrammed states and/or user defined information (e.g., image, label, and/or ID.) In general, the display driver circuit 40 is synchronized using an external clock signals 5g received through the I/O interface driver 10. Either synchronous or asynchronous mechanisms may be used.

In an alternate embodiment where the display driver circuit 40 includes the onboard microcontroller 55, the microcontroller 55 may be programmed to independently access the external register 50. Alternately, the display driver circuit 40 could receive a latch signal from the memory controller 20 to signal the display driver circuit 40 to access this external register 50 to retrieve the memory information.

In an embodiment, the memory controller may be bypassed entirely. In such an embodiment, an input comprising information for display may be recognized directly by a separate flexible display controller, or by display driver circuit 40, in a header of a serial data input stream. In such an embodiment, one or more data pins on the memory data bus may be shared and individually sensed by both the memory controller, the display controller, or the display driver circuit 40. In such an embodiment, the flexible display controller may operate in the background, independent of the memory controller, or the flexible display controller may operate intelligently with the memory controller.

In an embodiment, the polymeric display 45 may be an electrophoretic display, a polymer dispersed liquid crystal display, a cholesteric liquid crystal display, an organic light emitting devices display, a plastic-based LCD display, or other particle based display such as electronic paper. The display driver circuit 40 is configured to drive the particular type of polymeric display 45 used with the portable memory device 5.

The polymeric display 45 may be integrated into the portable memory device 5 by way of a flexible circuit board which couples the polymeric display 45 to the display driver circuit 40. In an embodiment, the polymeric display 45 is mounted superjacent to the memory controller 20 and disposed within or upon the housing of the portable memory device 5. The display driver circuit 40 may be attached to the physical structure of the polymeric display 45 and electrically connected to the memory controller 20 by way of the aforementioned flexible circuit board. In another embodiment, both the display driver circuit 40 and the polymeric display 45 may be integrated into the portable memory device 5 by a lamination process.

In an embodiment, a surface area of the display 45 is less than a surface area of a face of a housing on which the display is mounted.

FIG. 2A depicts an example diagram of a portable memory device 5 provided in a secure digital (SD) form factor in which a polymeric display 45a is encompassed longitudinally within the SD form factor. The placement, size and orientation of the polymeric display 45a is not critical. The polymeric display 45a may be disposed laterally as is shown in FIG. 2B or paracentrally as is shown in FIG. 2C.

The polymeric display 45a-45c may be used to display any number of items of information. Example information includes, but is not limited to, total memory capacity, available memory remaining, memory used, personal labels (e.g., family pets), graphics (e.g., graphic of a dog), a company logo, a symbol, a bar code or Universal Product Code (UPC), encoded or encrypted data, encoded or encrypted images, information indicating the date, time or place at which data was stored, a series number, date/time code or other unique identifying indicia to differentiate a particular portable memory device from other physically identical portable memory devices 5.

In other embodiments, a display panel of a portable memory device may display any other visually perceivable information and the scope of this disclosure includes integrating a generally planar display panel into a portable memory device that can display any conceivable displayable information.

FIG. 2D provides an alternate embodiment where the portable memory device 5 is embodied in a USB flash drive form factor. In this embodiment, the polymeric display 45d is oriented longitudinally. In other embodiments, the polymeric display 45d is oriented laterally, centrally, vertically, horizontally, angularly, or in any other suitable orientation.

4.0 Extensions and Alternatives

The foregoing described embodiments are provided as illustrations and descriptions and not intended to limit the scope of this disclosure to any precise form described. In particular, it is contemplated that functional implementation of the invention described herein may be implemented equivalently in hardware, software, firmware, and/or other available functional components or building blocks. Therefore, the specification and accompanying drawings are, accordingly, to be regarded in an illustrative rather than a restrictive sense.

In particular, no specific limitation is intended to usage of a particular form factor, type of polymeric display or memory type. Other variations and embodiments are possible in light of the above teachings, and it is not intended that this specification limit the scope of the disclosure.

What is claimed:

1. A portable memory device comprising:
a housing that conforms to a portable memory device form factor;
a memory controller in the housing and configured to determine memory information from a memory coupled to the memory controller, generate memory information signals in dependence on the determined memory information and output the memory information signals;
a flexible polymeric display panel on the housing;
a display driver in the housing and operatively coupled to the memory controller and configured to convert the memory information signals into visual representation signals and output the visual representation signals to the flexible polymeric display panel.

2. The portable memory device according to claim 1 wherein the display driver includes a microcontroller.

3. The portable memory device according to claim 1 wherein the flexible polymeric display panel is one of; an electrophoretic display, a polymer dispersed liquid crystal display, a cholesteric liquid crystal display, an organic light emitting devices display, a plastic-based liquid crystal display; and an electronic paper display.

4. The portable memory device according to claim 1 wherein the portable memory device is embodied in a form factor consisting of; a secure data card, a compact flash card, a memory stick, and a USB flash drive.

5. The portable memory device according to claim 1 wherein an image displayed on the flexible polymeric display panel is persistent without application of electrical power.

6. The portable memory device according to claim 1 wherein a portion of the memory coupled to the memory controller is sharable with the display driver.

7. The portable memory device according to claim 1 wherein the flexible polymeric display panel has a thickness in a range of about 100 to about 950 micrometers.

8. The portable memory device according to claim 1 wherein the flexible polymeric display panel has a thickness in a range of about 250 to about 450 micrometers.

9. The portable memory device according to claim 1 wherein the flexible polymeric display panel is coupled to a housing encompassing the portable memory device.

10. The portable memory device according to claim 9 wherein the flexible polymeric display panel is coupled to an area of the housing on one of; an interior surface, an exterior surface and between the interior and exterior surfaces.

11. The portable memory device according to claim 1 wherein the memory is one of; a read-only memory, a programmable read-only memory, an erasable programmable read-only memory, an electrically erasable programmable read-only memory, a flash memory and a random access memory.

12. The portable memory device according to claim 1 wherein the visual representation signals indicate one of a total memory capacity, available memory; assigned memory, a graphical image, and alphanumeric text, and any combination thereof.

13. A portable memory device having a flexible polymeric display panel comprising:
means for determining memory information from a memory associated with the portable memory device;
means for generating memory information signals in dependence on the determined memory information;
means for converting the memory information signals into visual representation signals; and,
means for outputting the visual representation signals on the flexible polymeric display panel.

14. The portable memory device according to claim 13 wherein the outputted visual representation signals is representative of one of a total memory capacity, available memory; assigned memory, a graphical image, and alphanumeric text and any combination thereof.

15. The portable memory device according to claim 13 wherein the flexible polymeric display panel has a thickness in a range of about 250 to about 450 micrometers.

16. The portable memory device according to claim 13 wherein the outputted visual representation signals are persistent without electrical power.

17. The portable memory device according to claim 13 wherein the portable memory device is embodied in a form factor consisting of; a secure data card, a compact flash card, a memory stick, and a USB flash drive.

18. The portable memory device according to claim 13 wherein the flexible polymeric display panel is one of; an electrophoretic display, a polymer dispersed liquid crystal display, a cholesteric liquid crystal display, organic light emitting devices display, a plastic-based liquid crystal display; and an electronic paper display.

19. The portable memory device according to claim 13 wherein the flexible polymeric display panel is coupled to an area of the housing on one of; an interior surface, an exterior surface and between the interior and exterior surfaces.

20. A memory device comprising:
a memory controller configured to determine memory information from a memory coupled to the memory controller, generate memory information signals in dependence on the determined memory information and output the memory information signals;
a flexible electrophoretic display panel;
a display driver operatively coupled to the memory controller and coupled to the flexible electrophoretic display panel and configured to convert the memory information signals into visual representation signals and output the visual representation signals on the electrophoretic display panel; and
a Secure Digital (SD) memory card housing that contains the memory controller, the memory, the display driver and the flexible electrophoretic display panel.

21. The memory device according to claim 20 wherein the display panel has a thickness in a range of about 100 to about 950 micrometers.

22. The memory device according to claim 20 wherein the display panel has a thickness in a range of about 250 to about 450 micrometers.

23. The memory device according to claim 20 wherein the display panel is coupled to a housing encompassing the portable memory device.

24. The memory device according to claim 9 wherein the display panel is coupled to an area of the housing on one of; an interior surface, an exterior surface and between the interior and exterior surfaces.

25. The memory device according to claim 20 wherein the memory is one of a read-only memory, a programmable read-only memory, an erasable programmable read-only memory, an electrically erasable programmable read-only memory, a flash memory and a random access memory.

26. The memory device according to claim 20 wherein the information is one of a total memory capacity, available memory; assigned memory, personalization information, identification information, a sequence value, a graphical image, and alphanumeric text, and any combination thereof.

27. The memory device of claim 20, further comprising a flexible display controller configured to detect display information in a header of a serial data input stream and coupled to one or more data pins of a memory data bus that are shared with the memory controller.

28. A memory device comprising:
a memory controller configured to determine memory information from a memory coupled to the memory controller, generate memory information signals in dependence on the determined memory information and output the memory information signals;
a flexible electrophoretic display panel;
an interface coupled to an external system and configured to receive a waveform from the external system having voltage levels configured to drive the flexible electrophoretic display panel and to convert the memory information signals into visual representation signals and output the visual representation signals on the electrophoretic display panel; and,
a memory card housing that contains the memory controller, the memory, and the interface, wherein the flexible electrophoretic display panel is on the housing.

29. The memory device of claim 28, wherein a surface area of the display panel is less than a surface area of a face of the memory card housing on which the display panel is mounted.

30. The memory device of claim 20, wherein a surface area of the display panel is less than a surface area of a face of the memory card housing on which the display panel is mounted.

31. The memory device of claim 1, wherein a surface area of the display panel is less than a surface area of a face of the housing on which the display panel is mounted.
